(19) United States
(12) Patent Application Publication
(10) Pub. No.: US 2026/0323230 A1
(43) Pub. Date: Oct. 15, 2026

(54) FIELD CANCELLATION FOR AUDIO TRANSDUCER COILS

(71) Applicant: Apple Inc., Cupertino, CA (US)

(72) Inventors: Sajjad MOHAMMADIYANGIJEH, Santa Clara, CA (US); Claudio NOTARANGELO, San Francisco, CA (US); Thomas M. JENSEN, San Francisco, CA (US)

(21) Appl. No.: 19/177,476

(22) Filed: Apr. 11, 2025

(51) Int. Cl. H04R 29/00; H04R 3/02; H04R 9/02

(52) U.S. Cl. CPC H04R 29/003; H04R 3/02; H04R 9/025

(57) ABSTRACT

An audio device may cancel an induced electrical current and induced voltage, generated by a stray magnetic field, in a transducer coil that is exposed to the stray magnetic field. When an induced voltage due is determined, an opposing voltage is generated and combined with the voltage used to drive an audio transducer to generate sound. When the audio transducer, including the transducer coil, receives the combined voltage, the audio transducer provides an electrical current, based on the combined voltage, the transducer coil drives a sound-generating component (e.g., diaphragm, surround), while the induced voltage due to the stray magnetic field is canceled based on the opposing voltage.

### TECHNICAL FIELD

This application is directed to audio devices, and more particularly, to cancelling an induced voltage from a magnetic field applied to a transducer coil of an audio device.

### BACKGROUND

Audio devices may generate acoustical energy in the form of audible sound.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an example of an audio system, in accordance with aspects of the present disclosure.

FIG. 2 illustrates a block diagram of an example audio device that may provide field cancellation, in accordance with aspects of the present disclosure.

FIG. 3 illustrates a partial cross sectional view of an audio device during operation, in accordance with aspects of the present disclosure.

FIG. 4 illustrates a block diagram of an audio device, showing an operation of the audio device for managing for an induced voltage at a transducer coil, in accordance with aspects of the present disclosure.

FIG. 5 illustrates a flow diagram showing an example of a process for managing an induced electrical current in an audio device, in accordance with aspects of the present disclosure.

FIG. 6 illustrates a flow diagram showing an alternate example of a process for managing an induced electrical current in an audio device, in accordance with aspects of the present disclosure.

FIG. 7 illustrates a flow diagram showing an alternate example of a process for managing an induced electrical current in an audio device, in accordance with aspects of the present disclosure.

FIG. 8 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to determining an induced voltage at a transducer coil of an audio transducer (e.g., audio speaker) and generating a cancelling, or offsetting, voltage that cancels the induced voltage. In smaller electronic devices (e.g., wearable earbuds), a power source (e.g., battery) may be positioned relatively close to the transducer coil. During operation of an audio transducer, the power source and/or a wire(s) connected to the power source may generate a stray magnetic field that induces an unwanted electrical current at the transducer coil, resulting in an induced voltage that may cause distortion or noise in the audio produced by the transducer coil.

Audio devices described herein are designed to effectively cancel the stray magnetic field, thereby cancelling the induced electrical current and induced voltage in the transducer coil. For example, audio devices described herein may measure, or sense, the induced electrical current in a transducer coil caused by the stray magnetic field and determine the induced voltage based on the measured induced electrical current. Further, audio devices described herein may generate and output an opposing voltage (e.g., opposite waveform, opposite magnitude) used to cancel the induced voltage. The opposing voltage may be combined with the voltage used to drive (e.g., acoustically drive) a transducer coil to generate sound. Moreover, the voltage used to generate sound may be combined with the opposing voltage prior to being provided to the transducer coil. The combined voltage not only causes the transducer coil to drive a sound-generating component (e.g., diaphragm, surround) to generate audible sound, but also offsets the induced electrical current and induced voltage due to the stray magnetic field. Beneficially, audio devices described herein that provide field cancellation (e.g., magnetic field cancellation) may provide enhanced audio quality for users.

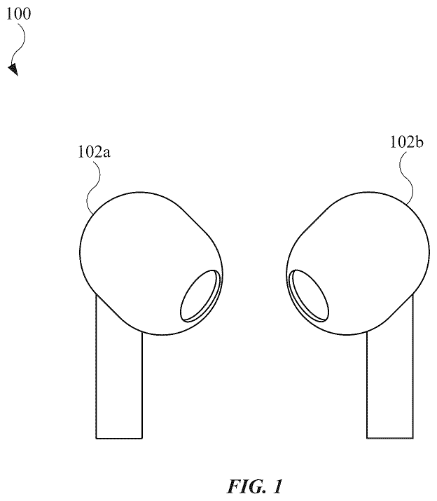

These and other embodiments are discussed below with reference to FIGS. 1-8. However, those skilled in the art will readily appreciate that the detailed description given herein with respect to these Figures is for explanatory purposes only and should not be construed as limiting.

FIG. 1 illustrates a perspective view of an example of an audio system 100, in accordance with aspects of the present disclosure. As shown, the audio system 100 includes an audio device 102a and an audio device 102b. Each of the audio devices 102a and 102b is designed to generate acoustical energy (e.g., soundwaves) in the form of audible sound. In one or more implementations, each of the audio devices 102a and 102b takes the form of an earbud, including a wireless earbud. In this regard, one of the audio devices 102a and 102b may be designed for a user's left ear and the remaining audio device of the audio devices 102a and 102b may be designed for a user's right ear. While the audio devices 102a and 102b are shown as a particular type of an audio device (e.g., earbud), in other embodiments, audio devices 102a and 102b may take other forms of audio devices. For example, the audio devices 102a and 102b may be combined to form of an audio headset (e.g., over-the-ear headset) or audio headphones. Further, the audio devices 102a and 102b may take the form of an audio transducer in electronic devices, including mobile wireless communication devices (e.g., smartphones), tablet computing devices, or laptop computing devices, as non-limiting examples.

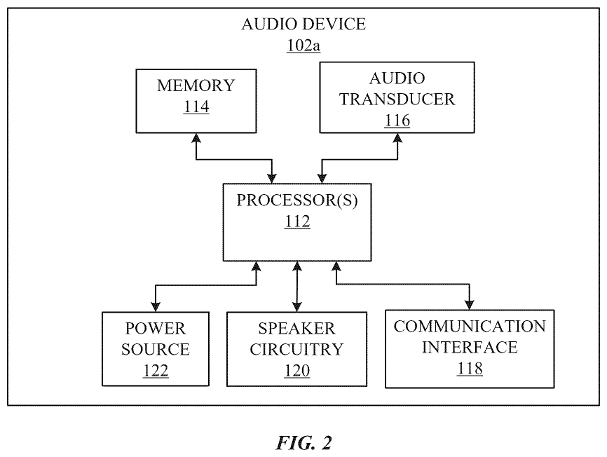

FIG. 2 illustrates a block diagram of an audio device 102a that may provide field cancellation, in accordance with aspects of the present disclosure. The audio device 102a shown in FIG. 1 may be implemented in other device for use with the subject technology, such as the audio device 102b (shown in FIG. 1). Variations in the arrangement and type of the components may be made without departing from the spirit or scope of the claims as set forth herein. Additional components, different components, or fewer components may be provided.

The audio device 102a may include one or more processors 112, a memory 114, an audio transducer 116, a communication interface 118, speaker circuitry 120, and a power source 122. The one or more processors 112 may include a central processing unit, a graphics processing unit, one or more microcontrollers, or a combination thereof. Further, the one or more processors 112 may include suitable logic, circuitry, and/or code that enable processing data and/or controlling operations of the audio device 102a. In this regard, the one or more processors 112 may be enabled to provide control signals to various other components of the audio device 102a. The one or more processors 112 may also control transfers of data between various portions of the audio device 102a. The one or more processors 112 may further implement an operating system or may otherwise execute code to manage operations of the audio device 102a.

The memory 114 may include suitable logic, circuitry, and/or code that enable storage of various types of information such as received data, generated data, code, and/or configuration information. The memory 114 may include volatile memory (e.g., random access memory (RAM)) and/or non-volatile memory (e.g., read-only memory (ROM), flash, and/or magnetic storage). In one or more implementations, the memory 114 may store user account data, and any other data generated in the course of performing the processes described herein.

The audio transducer 116 may include an audio speaker and a microphone. The audio transducer 116, taking the form of an audio speaker, may be utilized to convert electrical signals into acoustical energy in the form of audible sound. The audio transducer 116, taking the form of a microphone transducer, may be utilized to convert acoustical energy into electrical energy. The speaker circuitry 120 may provide a voltage to the audio transducer 116 to cancel an induced voltage that is based on an induced electrical current from a magnetic field to a transducer coil of the audio transducer 116.

The communication interface 118 may include suitable logic, circuitry, and/or code that enables wired or wireless communication, such as between the audio device 102a and a network. The communication interface 118 may include, for example, one or more of a BLUETOOTH® communication interface, an NFC interface, a Zigbee communication interface, a WLAN communication interface, a Universal Serial Bus (USB) communication interface, a cellular interface, or generally any communication interface. Accordingly, the communication interface 118 may establish a radio network, allowing the audio device 102a to communicate with another device (e.g., a mobile wireless communication device, a tablet computing device, or laptop computing device, as non-limiting examples).

The speaker circuitry 120 may be utilized for generating signals or commands to generate acoustical energy. Also, the speaker circuitry 120 may monitor a transducer coil (e.g., of the audio transducer 116). In this regard, the speaker circuitry 120 may measure an induced electrical current in transducer coil, determine an induced voltage based on the induced electrical current, and provide an opposing voltage.

The power source 122 may take the form of a battery, including a rechargeable battery. The power source 122 may store energy and provide the stored energy, as a direct current (DC) supply, to the one or more processors 112, the memory 114, the audio transducer 116, the communication interface 118, and the speaker circuitry 120.

In one or more implementations, the one or more processors 112, the memory 114, the audio transducer 116, the communication interface 118, and the speaker circuitry 120, and/or one or more portions thereof may be implemented in software (e.g., subroutines and code), may be implemented in hardware (e.g., an Application Specific Integrated Circuit (ASIC)), a Field Programmable Gate Array (FPGA), a Programmable Logic Device (PLD), a controller, a state machine, gated logic, discrete hardware components, or any other suitable devices) and/or a combination of both.

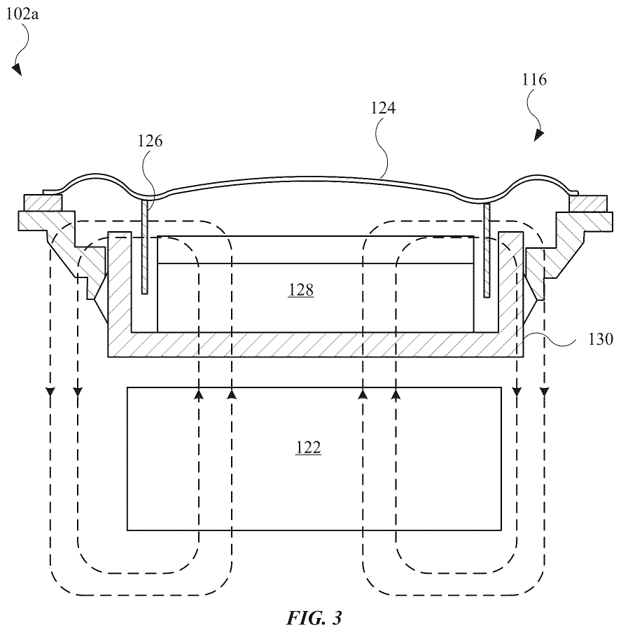

FIG. 3 illustrates a partial cross sectional view of an audio device 102a during operation, in accordance with aspects of the present disclosure. As shown, the audio device 102a includes an audio transducer 116 and a power source 122. The audio transducer 116 may take the form of an audio speaker. The audio transducer 116 may include a sound-generating component 124 (e.g., diaphragm), a transducer coil 126, a magnet 128 (e.g., permanent magnet), and a yoke 130.

During operation of the audio device 102a, the power source 122 may provide electrical current to the audio transducer 116. In particular, the electrical current may be provided to the transducer coil 126 in different (e.g., alternating) directions, causing the transducer coil 126 to form an electromagnet with changing magnetic polarity based electrical current provided in different directions. This in turn causes the transducer coil 126 to either be magnetically attracted or magnetically repelled by the magnet 128. The magnetic attraction/repulsion of the transducer coil 126 acoustically drives the sound-generating component 124, acoustically coupled with the transducer coil 126, to generate acoustical energy corresponding to an acoustic output of the audio transducer 116.

Also, the power source 122 (and/or wires or flexible circuits electrically coupled with the power source 122), when providing electrical current, may create a magnetic field(s), represented by magnetic field lines (shown in FIG. 3 as dotted lines) generated externally with the respect to transducer coil 126 and the audio transducer 116. While the yoke 130 may limit or prevent some of the magnetic field(s) from reaching the transducer coil 126, the yoke 130 may become saturated. As a result, the magnetic field(s) may stray through the transducer coil 126 as shown in FIG. 3. The stray magnetic field(s) from components (e.g., power source 122, flexible circuit(s)) outside of the transducer coil 126, if strong enough, may develop a coupling with the transducer coil 126. The stray magnetic field(s) may induce a voltage and thus induce an electrical current within the transducer coil 126, which, in addition to the main electrical current generating the desired acoustical energy, can interact with the magnet 128, causing extra and/or unintended vibration and/or noise.

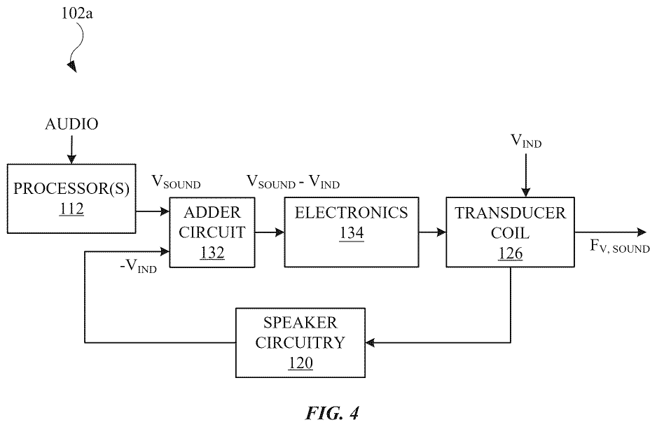

FIG. 4 illustrates a block diagram of the audio device 102a, showing an operation of the audio device 102a for managing for an induced voltage at the transducer coil 126, in accordance with aspects of the present disclosure. In addition to the transducer coil 126, the audio device 102a may include an adder circuit 132 and electronics 134.

During operation, the one or more processors 112 receive an audio signal (AUDIO) in the form of an electrical signal(s) and operate on the audio signal (AUDIO) to generate audio (e.g., music, voice, other sounds). Also, the one or more processors 112 may provide, for example, noise cancellation features, filtering, or the like. The one or more processors 112 may output a voltage to generate the desired sound (V_{SOUND}). The voltage to generate the desired sound (V_{SOUND}) may provide an applied electrical current to the transducer coil 126 to, for example, acoustically drive the transducer coil 126 and the sound-generating component 124 (shown in FIG. 3). Also, the transducer coil 126 may be exposed to a stray magnetic field due to, for example, one or more components (e.g., power source 122 shown in FIG. 3) of the audio device 102a. As a result, an additional electrical current may be induced in the transducer coil 126. The induced electrical current at the transducer coil 126 may be a function of the magnetic field sensed by the transducer coil 126. The induced electrical current may cause an induced voltage (V_{IND}) at the transducer coil 126, with the induced voltage (V_{IND}) also being a function of the magnetic field.

The adder circuit 132 may be used to combine multiple signals and output the sum of the signals. This will be shown and described in further detail below. Also, the adder circuit 132 may be substituted with other components, such as a multiplexer as a non-limiting example. The electronics 134 may be one or more electrical components of the audio device 102a, such as a circuit board or a flexible circuit, as non-limiting examples.

In one or more implementations, the speaker circuitry 120 may determine the voltage at the transducer coil 126 attributed to the induced voltage (V_{IND}). For example, the speaker circuitry 120 may receive an indication of an induced electrical current at the transducer coil 126 based on the induced voltage (V_{IND}) at the transducer coil 126. The speaker circuitry 120 may measure the voltage at the transducer coil 126. As a non-limiting example, the speaker circuitry 120 may perform a Fourier transform to decompose the voltage to determine the characteristics of the induced voltage (V_{IND}). In this regard, the transducer coil 126 may also function as a magnetic field sensor, as the induced voltage (V_{IND}) may be measured at the transducer coil 126 and used to calculate the magnetic field to which the transducer coil 126 is exposed. In one or more implementations, the speaker circuitry 120 compares the expected voltage (e.g., voltage of desired sound (V_{SOUND})) with the measured voltage. The induced voltage (V_{IND}) may be the difference between the expected voltage and the measured. Alternatively or in combination, the speaker circuitry 120 may measure an induced voltage when the audio device 102a is not in operation to determine the noise floor in order to determine the induced voltage (V_{IND}) during operation.

When the induced voltage (V_{IND}) is determined, the speaker circuitry 120 may generate an opposing voltage (−V_{IND}) to cancel the induced voltage (V_{IND}). For example, the opposing voltage (−V_{IND}) (e.g., offsetting voltage, cancelling voltage) may be characterized as a voltage that is the negative of the induced voltage (V_{IND}) in terms of the opposite magnitude and waveform. Based on the opposing voltage (−V_{IND}), an opposing electrical current may be generated to offset the induced electrical current at the transducer coil 126.

The speaker circuitry 120 may provide, as a feedback loop, the opposing voltage (−V_{IND}) to the adder circuit 132. It should be noted that the one or more processors 112 may perform its designated functions (e.g., audio processing, noise cancellation, filtering) independently of the feedback loop and accordingly, the one or more processors 112 may generate the desired sound (V_{SOUND}) without regard to the opposing voltage (−V_{IND}) generated by the speaker circuitry 120.

The voltage of desired sound (V_{SOUND}) and the opposing voltage (−V_{IND}) may be provided to the adder circuit 132. The adder circuit 132 may output a combined voltage (V_{SOUND}−V_{IND}) equal to the voltage sum of the voltage of desired sound (V_{SOUND}) and the opposing voltage (−V_{IND}). The combined voltage (V_{SOUND}−V_{IND}) may pass through the electronics 134 and to the transducer coil 126. In particular, the combined voltage (V_{SOUND}−V_{IND} may be provide to the transducer coil 126 while the induced voltage (V_{IND}) is at the transducer coil 126. In one or more implementations, the combined voltage (V_{SOUND}−V_{IND}) is used to generate an acoustic output (e.g., via the sound-generating component 124 shown in FIG. 3), with the acoustic output being based on the opposing voltage (−V_{IND}). As a result, when the transducer coil 126 is exposed to the stray magnetic field that causes an induced electrical current leading to an induced voltage (V_{IND}), the combined voltage (V_{SOUND}−V_{IND}) cancels the induced voltage (V_{IND}), resulting in the voltage of the desired sound (V_{SOUND}). Moreover, the force generated during operation of the audio device 102a is due, or substantially due, to the force due to the voltage of the desired sound (F_{V,SOUND}).

In one or more implementations, additional techniques may be used in the audio device 102a to determine the induced voltage (V_{IND}). For example, a current sensor, a secondary coil, and/or a microphone may be used to determine the induced voltage (V_{IND}). The secondary coil may be placed in proximity to the transducer coil 126 and the current sensor may measure the current at the secondary coil. The microphone may receive the acoustical energy generated the sound-generating component 124 (shown in FIG. 3) and the speaker circuitry 120 may analyze the electrical signals, based on the received acoustical energy from the microphone, to determine the presence of the induced voltage (V_{IND}) and to calculate an opposing voltage (-VIND).

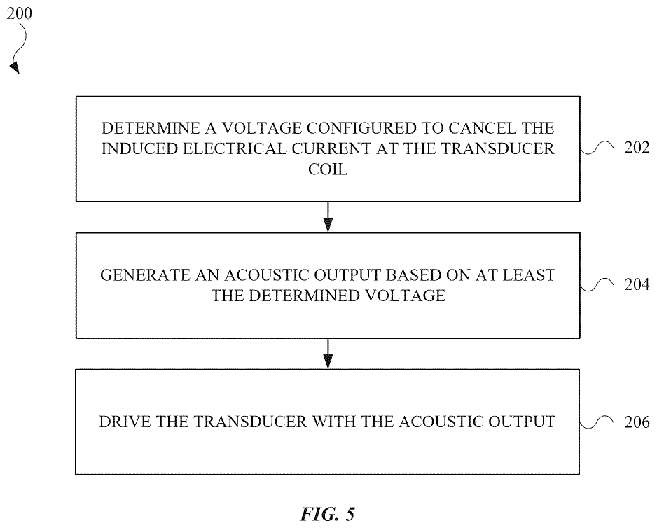

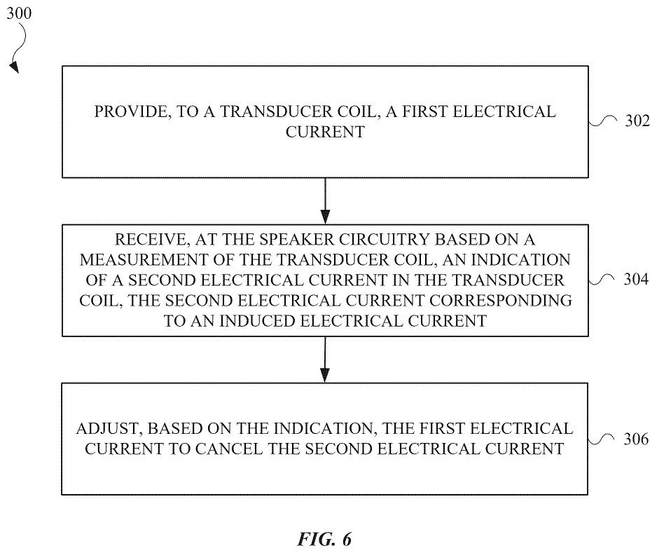

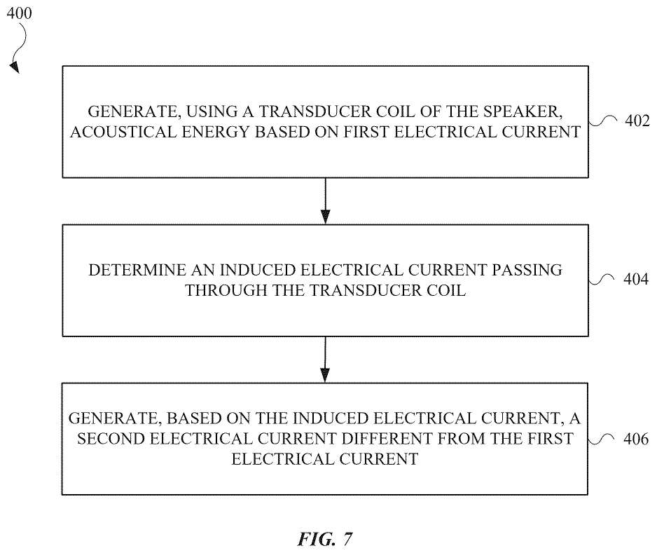

FIG. 5, FIG. 6 and FIG. 7 illustrate flow diagrams showing examples of one or more processes for managing an induced electrical current in an audio device, in accordance with implementations of the subject technology. One or more audio devices (e.g., audio devices 102a and 102b) may be used in part to conduct one or more steps of the example processes. For explanatory purposes, the respective processes shown in FIGS. 1-4 are primarily described herein with reference to the audio devices 102a and 102b, which may include an earbud. However, the respective processes shown in FIGS. 1-4 are not limited to the audio devices 102a and 102b, and one or more blocks (or operations) of the respective processes may be performed by one or more other components of other suitable apparatuses, devices, or systems. Further for explanatory purposes, some of the blocks of the respective processes are described herein as occurring in serial, or linearly. However, multiple blocks of the respective processes may occur in parallel. In addition, the blocks of the respective processes need not be performed in the order shown and/or one or more blocks of the respective processes need not be performed and/or can be replaced by other operations.

FIG. 5 illustrates a flow diagram showing an example of a process 200 for managing an induced voltage in an audio device, in accordance with aspects of the present disclosure. The process 200 may be performed under certain conditions. For example, the process 200 may be performed in response to a detection of an induced electrical current at a transducer coil of a transducer that is operating responsive to an applied electrical current.

At block 202, a voltage configured to cancel the induced electrical current at the transducer coil is determined. The voltage may be determined based on, for example, speaker circuitry 120 (shown in FIG. 4) used to determine an induced voltage at the transducer coil, with the induced voltage being a function of the induced electrical current.

At block 204, an acoustic output based on at least the determined voltage is generated. The determined voltage (e.g., opposing voltage (−V_{IND}) shown in FIG. 4) may be a function (e.g., negative) of the induced voltage (V_{IND}) (shown in FIG. 4).

At block 206, the transducer is driven with the acoustic output. For example, the transducer coil 126 (shown in FIGS. 3 and 4), and in turn the sound-generating component 124 (shown in FIG. 3) may be driven by the combined voltage (V_{SOUND}−V_{IND}), which corresponds to the acoustic output.

FIG. 6 illustrates a flow diagram showing an alternate example of a process 300 for managing an induced voltage in an audio device, in accordance with aspects of the present disclosure. The process 300 may be performed by, for example, speaker circuitry of a device (e.g., audio device, audio speaker, speaker device).

At block 302, a first electrical current is provided to a transducer coil. The first electrical current may be based on a voltage of desired sound (V_{SOUND}) (shown in FIG. 4).

At block 304, an indication of a second electrical current in the transducer coil is received at the speaker circuitry based on a measurement of the transducer coil. The second electrical current may include an induced electrical current, which corresponds to the induced voltage (V_{IND}) (shown in FIG. 4).

At block 306, the first electrical current is adjusted, based on the indication, to cancel the second electrical current. The first electrical current, based on based on a voltage of desired sound (V_{SOUND}), may be adjusted by adding electrical current based on an opposing voltage (e.g., opposing voltage (−V_{IND}) (shown in FIG. 4), with the added electrical current cancelling the induced electrical current based on the induced voltage (V_{IND}) (shown in FIG. 4).

FIG. 7 illustrates a flow diagram showing an alternate example of a process 400 for managing an induced voltage in an audio device, in accordance with aspects of the present disclosure. The process 400 may be performed by, for example, speaker circuitry of a device (e.g., audio device, audio speaker, speaker device).

At block 402, an acoustical energy is generated, using a transducer coil of the audio transducer, based on first electrical current. The acoustical energy may be generated on electrical current corresponding to a voltage of desired sound (V_{SOUND}) (shown in FIG. 4).

At block 404, an induced electrical current, caused by a magnetic field, passing through the transducer coil is determined. The induced electrical current passing through the transducer coil (e.g., transducer coil 126 shown in FIGS. 3 and 4) may correspond to the induced voltage (V_{IND}) (shown in FIG. 4) at the transducer coil. The magnetic field may include a stray magnetic field resulting from, for example, a power source (e.g., power source 122 shown in FIGS. and 3).

At block 406, second electrical current different from the first electrical current is generated, based on the induced electrical current. The second electrical current may correspond to an opposing voltage (e.g., opposing voltage (−V_{IND}) (shown in FIG. 4). The second electrical current is configured to cancel the induced electrical current caused by the magnetic field.

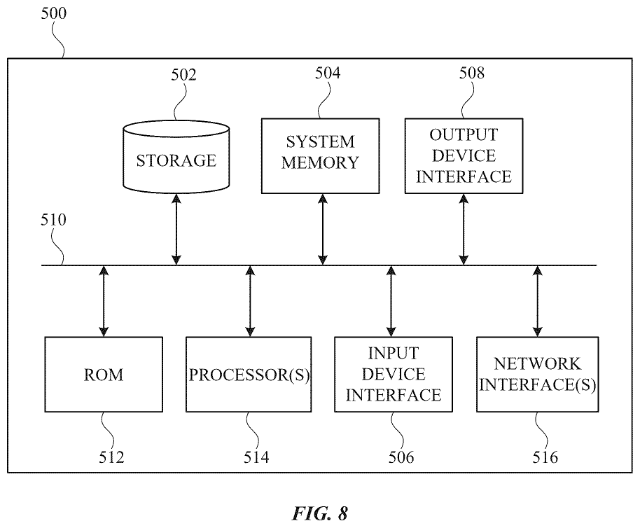

FIG. 8 illustrates an electronic system 500 with which one or more implementations of the subject technology may be implemented. The electronic system 500 can be, and/or can be a part of, the audio devices 102a and 102b as shown in FIG. 1 or the audio device 102a shown in FIG. 4. The electronic system 500 may include various types of computer readable media and interfaces for various other types of computer readable media. The electronic system 500 includes a bus 510, one or more processing units 514, a system memory 504 (and/or buffer), a ROM 512, a permanent storage device 502, an input device interface 506, an output device interface 508, and one or more network interfaces 516, or subsets and variations thereof.

The bus 510 collectively represents all system, peripheral, and chipset buses that communicatively connect the numerous internal devices of the electronic system 500. In one or more implementations, the bus 510 communicatively connects the one or more processing units 514 with the ROM 512, the system memory 504, and the permanent storage device 502. From these various memory units, the one or more processing units 514 retrieves instructions to execute and data to process in order to execute the processes of the subject disclosure. The one or more processing units 514 can be a single processor or a multi-core processor in different implementations.

The ROM 512 stores static data and instructions that are needed by the one or more processing units 514 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing units 514 may need at runtime. In one or more implementations, the processes of the subject disclosure are stored in the system memory 504, the permanent storage device 502, and/or the ROM 512 (which are each implemented as a non-transitory computer-readable medium). From these various memory units, the one or more processing units 514 retrieves instructions to execute and data to process in order to execute the processes of one or more implementations.

The bus 510 also connects to the input device interface 506 and output device interface 508. The input device interface 506 enables a user to communicate information and select commands to the electronic system 500. Input devices that may be used with the input device interface 506 may include, for example, alphanumeric keyboards and pointing devices (also called “cursor control devices”). The input device interface 506 may enable, for example, the display of images generated by electronic system 500. Output devices that may be used with the input device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 510 also couples the electronic system 500 to one or more networks and/or to one or more network nodes through the one or more network interfaces 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, and/or any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
in response to detecting an induced electrical current at a transducer coil of a transducer that is operating responsive to an applied electrical current:
determining a voltage configured to cancel an induced electrical current at the transducer coil;
generating an acoustic output based on at least the determined voltage; and
driving the transducer with the acoustic output.

2. The method of claim 1, wherein the induced electrical current is induced in the transducer coil by a magnetic field generated externally to the transducer coil.

3. The method of claim 1, further comprising while the induced electrical current is detected at the transducer coil, driving the transducer coil with the acoustic output.

4. The method of claim 1, wherein generating the acoustical comprises generating an opposing electrical current configured to cancel the induced electrical current.

5. The method of claim 4, further comprising:
measuring, at the transducer coil, the induced electrical current;
determining, based on the induced electrical current, a first voltage; and
generating, based on the first voltage, a second voltage opposite the first voltage.

6. The method of claim 1, further comprising receiving, from a power source, a direct current (DC) supply, wherein the induced electrical current is induced by a magnetic field generated by the power source.

7. The method of claim 1, wherein detecting the induced electrical current in the transducer coil comprises sensing the transducer coil for the induced electrical current.

8. The method of claim 1, wherein detecting the induced electrical current in the transducer coil comprises detecting, using a microphone, the acoustic output generated by the transducer coil.

9. The method of claim 8, further comprising determining, based on the acoustical output, the voltage.

10. A speaker comprising speaker circuitry configured to:
provide, to a transducer coil, a first electrical current;
receive, at the speaker circuitry based on a measurement of the transducer coil, an indication of a second electrical current in the transducer coil, the second electrical current corresponding to an induced electrical current; and
adjust, based on the indication, the first electrical current to cancel the second electrical current.

11. The speaker of claim 10, further comprising:
determining one or more characteristics of the second electrical current; and
adjusting, based on the one or more characteristics, the first electrical current.

12. The speaker of claim 11, wherein the one or more characteristics comprise a voltage based on the electrical current.

13. The speaker of claim 11, wherein the one or more characteristics comprise a waveform based on the electrical current.

14. The speaker of claim 10, wherein receiving the indication comprises receiving, while providing the first electrical current, the indication.

15. The speaker of claim 10, further comprising, in response to the indication:
measuring the second electrical current; and
adjusting, based on the measuring, the first electrical current such that the transducer coil drives a sound-generating component to generate acoustical energy without the second electrical current.

16. The speaker of claim 10, wherein receiving the indication comprises monitoring, using a microphone, acoustical energy generated by the transducer coil and a sound-generating component.

17. A device, comprising:
an audio transducer; and
speaker circuitry configured to:
generate, using a transducer coil of the audio transducer, acoustical energy based on first electrical current;
determine an induced electrical current passing through the transducer coil; and
generate, based on the induced electrical current, a second electrical current different from the first electrical current, wherein the second electrical current is configured to cancel the induced electrical current.

18. The device of claim 17, further comprising a power source, wherein the induced electrical current is caused by a magnetic field based on the power source.

19. The device of claim 17, wherein:
the induced electrical current causes a first force to be applied to the transducer coil; and
the second electrical current prevents the first force from being applied to the transducer coil.

20. The device of claim 17, wherein the speaker circuitry is further configured to:
determine one or more characteristics of the induced electrical current; and
generate, based on the one or more characteristics, the second electrical current.
